(19) United States
(12) Patent Application Publication
(10) Pub. No.: US 2012/0290612 A1
(43) Pub. Date: Nov. 15, 2012

(54) N-DIMENSIONAL DATA SEARCHING AND DISPLAY

(76) Inventor: Rajan V. RITOE, Delft (NL)

(21) Appl. No.: 13/335,823

(22) Filed: Dec. 22, 2011

Related U.S. Application Data
(60) Provisional application No. 61/484,471, filed on May 10, 2011.

(51) Int. Cl. G06F 17/30

(52) U.S. Cl. 707/770; 707/E17.056

(57) ABSTRACT

Methods, apparati, and computer-readable media for performing computerized data searches. In a method embodiment of the present invention, a server (2) receives a search request from a user (14). The server (2) accesses at least one computerized database (22), and searches the database(s) (22) along at least two dimensions. The server (2) then conveys the search results to the user (14) in a manner that preserves the multi-dimensional information.

This patent application claims the benefit of commonly owned U.S. provisional patent application 61/484,471 filed May 10, 2011 entitled “Customized Online Search (Yooray)”, which provisional patent application is hereby incorporated by reference in its entirety into the present patent application.

### TECHNICAL FIELD

This invention pertains to the field of performing computerized searches of datasources for useful information.

### BACKGROUND ART

Concerning current Internet searching, a typical Web search results in a one-dimensional list of hyperlinks, referring to pages which contain the query. This is illustrated in FIG. 1. Currently, it is impossible or very inconvenient for the user to add new search criteria, such as subject, location, or time of publication, to the original query.

For example, a typical prior art search system, such as the Google Wonder Wheel system illustrated in FIG. 11, shows only terms containing the search word. In this example, a search was performed on “Leonardo”. Wonder Wheel has returned just a list of expressions that contain the word “Leonardo”, such as Leonardo Di Caprio and Leonardo Hotel, as illustrated in FIG. 11. In the present invention, on the other hand, substantively related concepts are produced by the search (see FIG. 12).

In the prior art, changing a query to make it more specific is cumbersome; the system is rigid. The user receives just static and fixed information in response to his or her query. The information and the individual steps towards finding it cannot be customized (or modeled) by the user, but are fixed by the application. Prior art applications do not allow the user to look for possible connections between or among topics/queries. It is not possible to navigate search results of several queries at the same time. It is not possible to add extra information to queries. Linking a topic/query to its specific moment in time is not an easily accessible feature. Search windows do not allow the user to link a query to its specific location. It is not possible to connect a topic both to its specific moment in time and its location. All of this means that when the desired result is not found, the user needs to begin a new search, instead of adjusting his or her query.

There are no known prior solutions to these problems. Currently, regular search engines offer very cumbersome features that involve “syntax” marks, but this does not lead to the same kind of result. Some search engines offer a search tab, which effectively narrows searches down, but this cannot be used to display and navigate several topics with their time/place data.

The present invention addresses and remedies these and other problems.

### DISCLOSURE OF INVENTION

The present invention comprises methods, apparati, and computer-readable media for performing computerized data searches. In a method embodiment of the present invention, a server (2) receives a search request from a user (14). The server (2) accesses at least one computerized database (22), and searches the database(s) (22) along at least two dimensions. The server (2) then conveys the search results to the user (14) in a manner that preserves the multi-dimensional information.

### BRIEF DESCRIPTION OF THE DRAWINGS

These and other more detailed and specific objects and features of the present invention are more fully disclosed in the following specification, reference being had to the accompanying drawings, in which:

FIG. 1 is a depiction of a typical prior art search, which produces search results along one dimension only.

FIG. 2 is a block diagram of apparatus suitable for carrying out the present invention.

FIG. 3 is an illustration of a human user 14 using the present invention via a tablet computer 1.

FIG. 4 is an illustration showing a search result bubble 40 of the present invention.

FIG. 5 is an illustration showing search results in the present invention displayed in three dimensions.

FIG. 6 is an illustration of sub-bubbles 60 produced by the present invention.

FIG. 7 is an illustration of deletion of a sub-bubble 60(3).

FIG. 8 is an illustration of two sub-bubbles 60(1) and 60(2) being expanded to reveal underlying one-dimensional search result lists 41(1), 41(2).

FIG. 9 is an illustration of the combination of two search bubbles 40.

FIG. 10 is an illustration of linear search results 41 being displayed on user display 15.

FIG. 11 is an illustration of a prior art search result.

FIG. 12 is a sketch showing that the present invention finds and displays related information by substantive content.

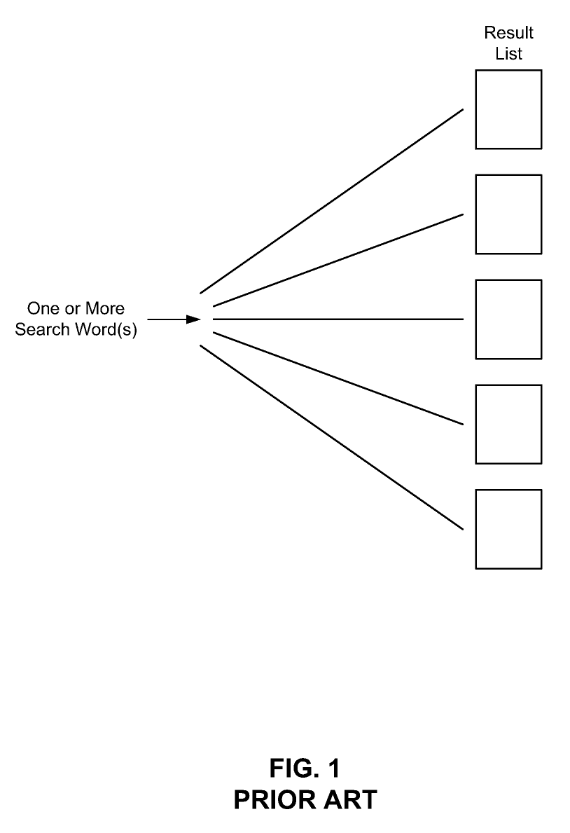

### DETAILED DESCRIPTION OF THE PREFERRED EMBODIMENTS

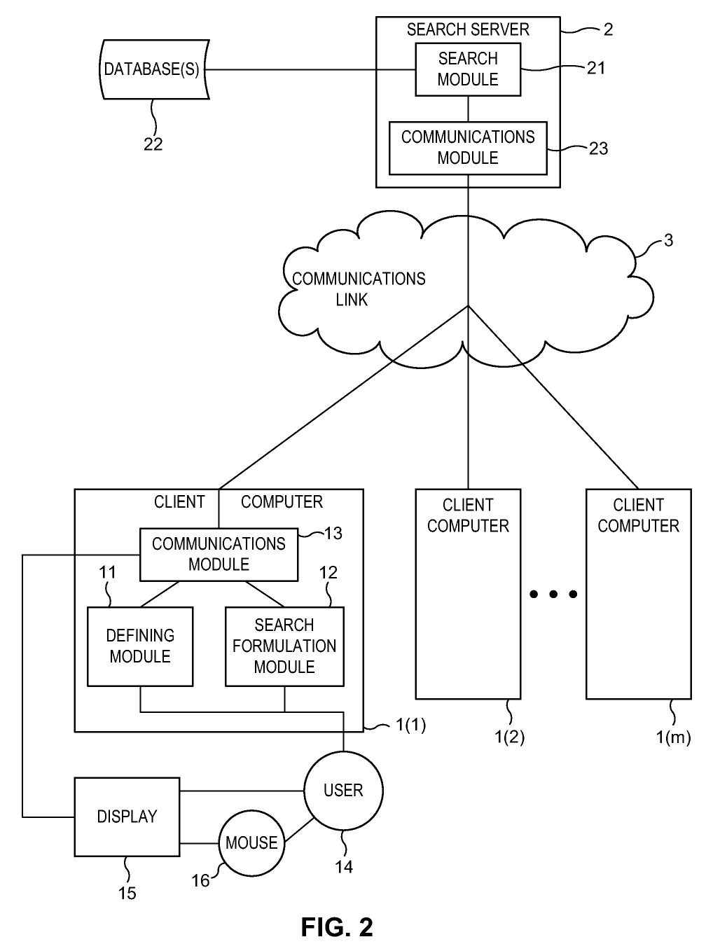

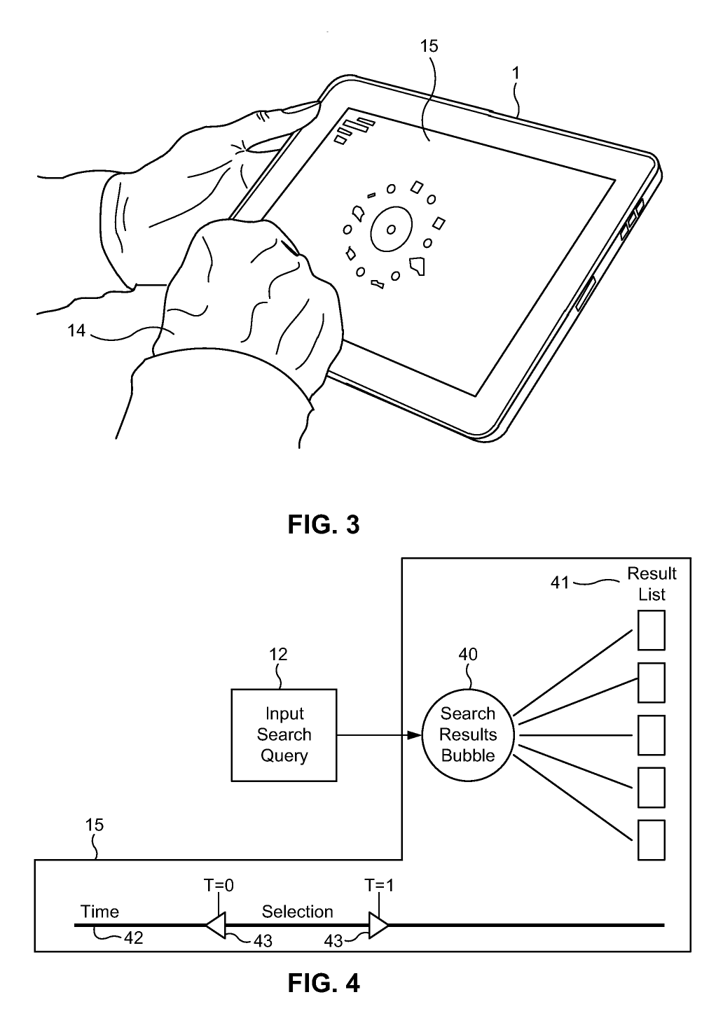

FIG. 2 is a block diagram illustrating the present invention. Search server 2 is a digital computer that performs the searching by means of accessing one or more databases 22. Server 2 can reside on the World Wide Web or elsewhere. Search module 21 is the module associated with server 2 that performs the searching. Server 2 also comprises a communications module 23 for receiving information from and sending information to one or more client computers 1.

Databases 22 can comprise any one or a combination of any of the following databases: one or more network databases; one or more existing Internet databases; one or more cloud databases; and one or more proprietary networks (“+databases”). As used herein, a cloud database is a database that is broken down into several pieces, the pieces being located at several different locations on the Internet for reasons of security.

Databases 22 can be different types. For example, the set of databases 22 being searched can include the public Internet plus proprietary networks consisting of Twitter, Facebook, and cell phone records. The ability to search this number and variety of databases 22 can be very useful when, for example, the server 2 is used by law enforcement in solving crimes.

The type of search that search module 21 performs is a function of the input search query. For example, if the search query includes words, e.g., keywords, an algorithm within search module 21 can entail counting the number of times that the keyword(s) appear(s) in the target databases 22. When the input search query includes an image such as a photograph, an algorithm within search module 22 can include means for segmenting and categorizing pixels within the image, and then comparing the categorized results with information in the database(s) 22. Module 21 can include sophisticated techniques to look for relationships between the input search query and the information within database(s) 22, including techniques of neural programming, artificial intelligence, semantic analysis, syntactic analysis, optical character recognition, etc.

FIG. 2 illustrates m client computers 1. Each client 1 is a digital computer. Clients 1 and server 2 can communicate with each other over any communications link 3 (or combination of links 3), such as the Internet, a wired network, a wireless network, a local area network, a wide area network, etc.

Each client computer 1 is normally controlled by a human user 14, who communicates with computer 1 by a keyboard or other device (not illustrated). However, in some applications, some or all of the operations of computer 1 can be performed automatically without human intervention. Display 15 is associated with each computer 1, and enables user 14 to visually see results of the searches performed by server 2, as well as to modify the searches, as will be described in more detail below. These modifications can be performed by user 14 activating an input device, such as mouse 16, coupled to display 15.

Computer 1 typically comprises defining module 11, search formulation module 12, and communications module 13. Defining module 11 accepts input queries and input parameters specified by user 14. An example of such a parameter is the number n of dimensions that user 14 wishes to be a part of the search. Defining module 11 also receives input from user 14 that defines what the dimensions shall be. Search formulation module 12 receives input search queries from user 14, and formulates these queries into a format that can be understood by server 2. Communications module 13 produces the output signals that convey the information from computer 1 to computer 2.

The search request (search query) that is input by user 14 to search formulation module 12 can comprise any one or more of the following, alone or in combination: a search string, a keyword, a natural language expression, an entry from within a pre-established menu of entries, a canonical expression, an image, a video, a fingerprint, a retinal scan, a handwritten entry, a touch on display 15.

In the case where the search query includes words, search formulation module 12 performs preprocessing to delete from the query common words such as “a” and “the”.

In the case where the search query is not a language expression, e.g., an image, video, or something else, search formulation module 12 similarly performs preprocessing to delete from the query non-relevant information/data.

Each module illustrated in FIG. 2 can be implemented in any combination of hardware, firmware, and/or software. When implemented in software, the modules can reside on any physical medium or media, such as one or more hard disks, floppy disks, flash drives, optical disks, magnetic tape, hardware for a cloud, or any combination thereof.

FIG. 4 is an illustration showing the basic workings of the invention from the point of view of user 14. The input search query, as formulated by search formulation module 12, is sent to search server 2, which produces search results and sends them back to user 14. A search results bubble 40 appears on display 15. As used herein, “search results bubble” is a generic term that includes any graphical representation of the search results.

Bubble 40 is the key to modeling and adjusting queries. This is done by user 14 activating bubble 40, e.g., by clicking on or around bubble 40 using mouse 16, or, alternatively, by tapping a touch screen such as display 15. The size, shape, color, and/or type of image (for example, what kind of icon) of bubble 40 is related (e.g., proportional) to the amount and/or content of the search results obtained by search module 21.

In some embodiments, user 14 clicks on the image of bubble 40 that appears on display 15 using mouse 16. The click can be a single click or a double click, and can be a left click or a right click, depending upon the type of hardware and software that is being used. One pre-established type of clicking results in a one-dimensional set of links or other information, organized as result list 41. Alternative to clicking, user 14 can use any other means to activate bubble 40, such as activating bubble 40 with a macro, arrow key on a keyboard, touch command on the display 15, or any other means of activation.

In the embodiment illustrated in FIG. 4, a timeline 42 also appears on display 15. This is owing to the fact that when user 14 requested the search, he or she included “time” as one of the requested dimensions, by inputting that request into defining module 11. For example, this request can be made by user 14 selecting the word “time” from a drop-down menu that appears on display 15. This setting as requested by user 14 can be automatic if user 14 wishes it, so that the setting will be automatic with following sessions of use. Time is one of the possible dimensions of the multi-dimensional search. Other common dimensions can include location, relevance, price, profit, and revenue. Retrieved data pertaining to the remaining n-1 dimensions is contained within bubble 40. FIG. 4 illustrates the simple case where n=2, and thus bubble 40 contains just the second dimension of the search. Where n=2, one of the dimensions, in this case, the dimension encapsulated within bubble 40, can be the “relevance” dimension.

“Location” can mean the geographical location of the server that posted the data to the database 22, the GPS coordinate on a picture that is located within database 22, location of certain preselected content within an element of data found within database 22, a portion of a retrieved graphic image, a location on a map of a museum, or any definition of geographical location. Alternatively, the “location” dimension can be any location that is represented as other than a geographical location.

For example, if database 22 includes a photograph of a car made in India, search module 21 outputs “India” for the location. In this case, India is a geographical location. The location data is then sent back to client computer 1 in a format such that computer 1 outputs a map on display 15. The map can be a map of the world with a cylinder positioned over each country that manufactures cars, with the height of the cylinder being proportional to the number of different car marques manufactured in that country.

The “time” dimension 42 can be defined as past time, current time, and/or future time, i.e., a prediction of what will happen in the future. “Time” can represent the time that a certain publication within database 22 was published, the time that the publication was posted within database 22, or some other time. The time scale 42 depicted on display 15 can be linear or non-linear, such as exponential or logarithmic.

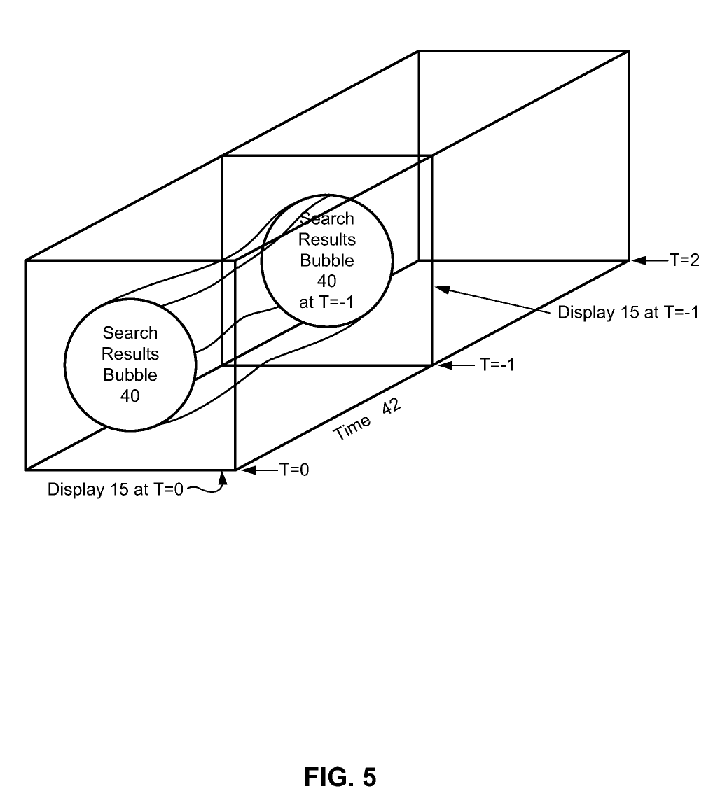

Superimposed upon timescale 42 in FIG. 4 are two duration icons 43 which represent the beginning and ending points of the duration within the overall time for which the user 14 wishes to see results. This is illustrated in FIG. 5, a three-dimensional representation showing what is displayed on display 15 at time t=0 and at time t=1, as well as at points in between. The size of bubble 40 varies between these two times. At each point in time between t=0 and t=1, the contents of bubble 40 vary based upon the time. In practice, the contents of bubble 40 vary incrementally rather than continuously. In other words, the time dimension 42 has an atomic unit, such as one day, which cannot be divided further. As an example, let us assume that user 14 has requested a search for news articles containing the words “Herman Cain”, and then bracketed that time period, so that t=0 corresponds to Oct. 23, 2011 and t=1 corresponds to Nov. 4, 2011. In this case, the bubble 40 at t=0 represents all the retrieved articles posted on the Internet referring to Herman Cain on Oct. 23, 2011,and bubble 40 at t=1 represents all the retrieved articles pertaining to Herman Cain posted on the Internet on Nov. 4, 2011. At the two end dates, or any date in between, user 14 can activate bubble 40 and obtain a list 41 giving links to all of the articles for that particular day.

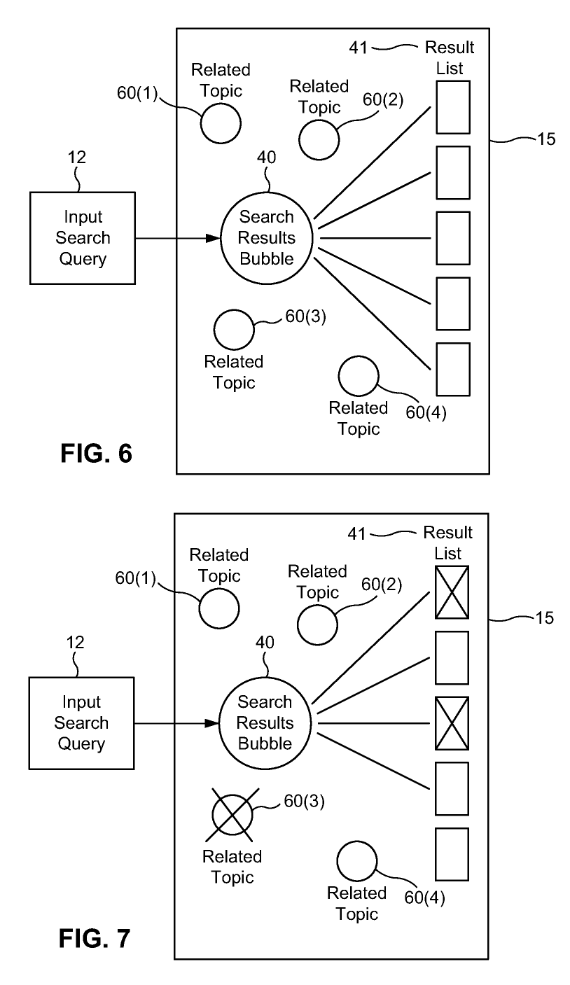

In one embodiment of the present invention, illustrated in FIG. 6, activating search results bubble 40 in a first manner (such as a single click of mouse 16) produces a series of sub-bubbles 60, while activating search results bubble 40 in a second manner (such as user 14 double-clicking mouse 16) results in an expansion and portrayal of all of the granular search result elements within bubble 40 in the form of a one-dimensional result list 41, e.g., a list of hyperlinks to locations on the Internet. In this embodiment, sub-bubbles 60 pertain to topics that are related to the main topic in search results bubble 40. This is further illustrated in FIG. 12, where the main search results bubble 40 gives results for a search that was performed on the keyword “Egypt”. Activating bubble 40 in the first manner results in six sub-bubbles 60, which represent six related topics, namely, tourism, pyramids, demonstrations, Mubarek, police, and Pharaoh. In this example, the sub-bubbles 60 represent subsets of the information contained within the primary bubble 40. The system was configured to produce six sub-bubbles 60, either preset, or by user 14 having inputted said information into defining module 11, and was further instructed to have the sub-bubbles 60 contain subsets of the data that was produced in the main search results bubble 40. In other embodiments, the system could, for example, be instructed to produce in the sub-bubbles 60 information pertaining to countries proximate to the country of the main bubble 40. In that case, the sub-bubbles 60 would contain information pertaining to Israel, Somalia, Lebanon, etc.

In the FIG. 6 embodiment, several levels of sub-bubble 60 can be produced. FIG. 6 shows two such levels. The first level contains just search results bubble 40, and the second level contains four sub-bubbles 60. The number of levels is arbitrary. When the lowest level is reached, activating a sub-bubble 60 even in the first manner will produce a one-dimensional list 41 of the data elements contained within that sub-bubble 60. Different sub-bubbles 60 in a given level can contain different numbers of sub-levels. For example, in FIG. 6, sub-bubble 60(1) can be at the lowest level, in which case activating sub-bubble 60(1) even in the first manner will result in the aforesaid result list 41. However, sub-bubble 60(2) can contain several lower sub-levels, such that activating sub-bubble 60(2) in the first manner will not produce a result list 41, but rather in a deeper sub-level of sub-bubbles 60.

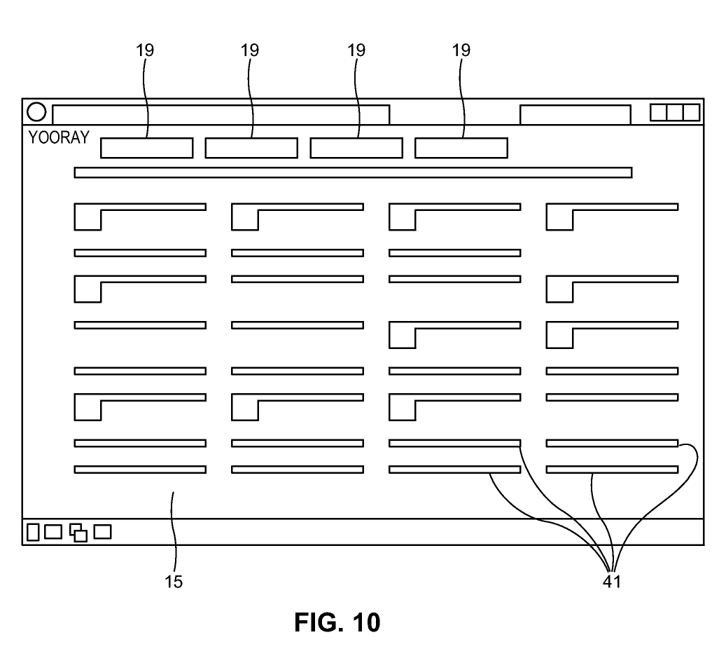

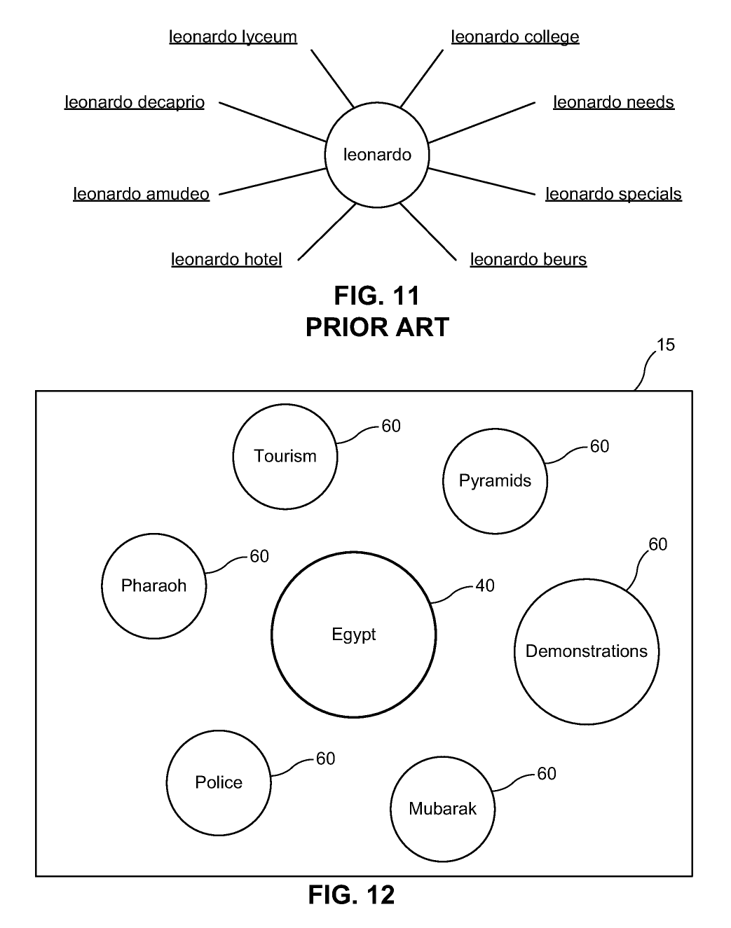

The system can be configured to produce an historical list of the sub-bubbles 60 that were activated, by displaying these historical residues (“crumbs”) 19 on display 15. This is illustrated in FIG. 10. In this embodiment, the user 14 can go back to any previous level of search, by clicking (or otherwise activating) on the residue 19 associated with that level.

In this multi-level embodiment, the user 14 can, at any time, switch from a sub-bubble 60 drill-down to production of a one-dimensional list 41, or vice versa, by activating the other manner of activation, e.g., by right clicking rather than left clicking mouse 16.

At any time during the search, user 14 can input new or revised information into defining module 11 to adjust and/or reset the contours of the search, e.g., by changing the number of dimensions, redefining the definitions of the search dimensions, changing the number of sub-bubbles 60 displayed when bubble 40 is activated, changing the substantive relationship between bubble 40 and sub-bubbles 60, etc.

In the embodiment illustrated in FIG. 7, the user can delete topics or sub-topics that the user 14 is not interested in. For example, in FIG. 7, the user has deleted sub-bubble 60(3). This results in deletion of the unwanted search results, and an adjustment in the size of bubble 40 and result list 41.

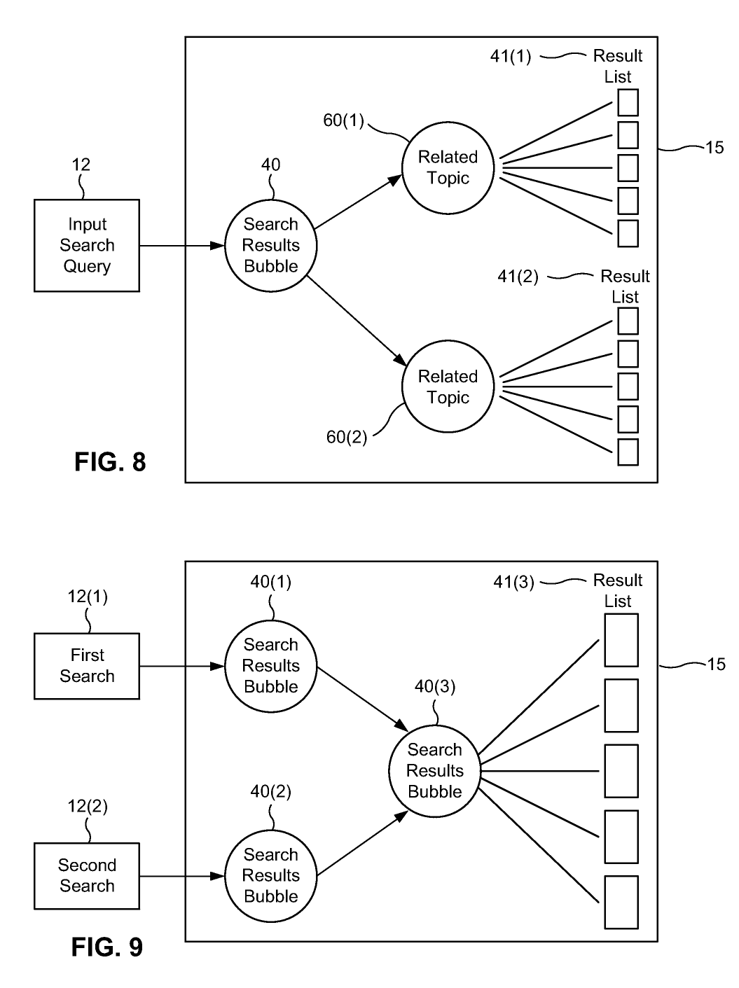

FIG. 8 shows the results of the user 14 activating sub-bubbles 60(1) and 60(2) in a manner to produce two result lists 41. As can be seen, two different result lists 41(1), 41(2) are produced, and are displayed on display 15.

One of the important features of the present invention is illustrated in FIG. 9, which shows that user 14 can request a plurality of separate searches simultaneously, and that a corresponding plurality of search results bubbles 40 will be displayed simultaneously on display 15. In FIG. 9, the user 14 has requested two searches, and therefore two search results bubbles 40(1), 40(2) are displayed. An important feature of the present invention is that the results of the two or more searches can be readily combined, e.g., by user 14 dragging, using mouse 16, one of the bubbles, in this case bubble 40(2), over the other bubble, in this case bubble 40(1). The system then looks for connections between the two search topics. The result is a new bubble 40(3), which combines the two search results. This can be done, for example, by communications module 13 sending a “combined search alert” to search module 21 via communications module 23. Then search module 21 looks for these new connections, and sends them back to client computer 1, which then displays them as bubble 40(3) on display 15. In the FIG. 9 embodiment, bubble 40(3) can be activated as before, to produce sub-bubbles 60 and/or a result list 41(3).

The above description is included to illustrate the operation of the preferred embodiments, and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A computer-implemented method for performing data searches, said method comprising the steps of:
receiving a search request from a user;
accessing at least one computerized database;
searching the database(s) along at least two dimensions; and
conveying the search results to the user in a manner that preserves the multi-dimensional information.

2. The method of claim 1 wherein the dimensions comprise location, time, and relevance.

3. The method of claim 1 wherein the method is performed by a search server, and the searched database(s) comprise at least one database from the group consisting of:
any network database;
an existing Internet database;
a cloud database; and
a proprietary network (+database).

4. The method of claim 1 wherein the search results conveyed to the user are grouped within a search results bubble.

5. At least one computer-readable medium containing computer programming instructions for:
receiving a search request from a user;
accessing at least one computerized database;
searching the database(s) along at least two dimensions; and
conveying the search results to the user in a manner that preserves the multi-dimensional information.

6. Apparatus for performing computerized data searches, said apparatus comprising:
an input module for receiving search queries from a user;
coupled to the input module, a search module for performing searches on at least one database and along at least two dimensions; and
coupled to the search module, a communications module for conveying search results to the user while preserving the multi-dimensional information.

7. The apparatus of claim 6 wherein at least one of the search module and communications module is adapted to organize the search results in the form of a search results bubble.

8. A computer-implemented method for searching for useful information, said method comprising the steps of:
formulating a search request comprising at least two preselected dimensions;
conveying the search request to a server; and
receiving from the server search results organized along the preselected dimensions.

9. The method of claim 8 wherein:
the search results received from the server are organized in the form of a search results bubble; and
activating the bubble uncovers relationships among search result elements contained within the bubble.

10. The method of claim 9 wherein activating the bubble produces a preselected number of sub-bubbles, each sub-bubble containing information related to information contained within the bubble.

11. The method of claim 10 wherein:
activating a sub-bubble reveals a deeper layer of subsidiary sub-bubbles; and
said sub-bubble activating step is repeated until an atomic level of sub-bubbles is reached; wherein:
said atomic level comprises at least one atomic sub-bubble consisting of a list of search result elements.

12. The method of claim 10 wherein:
activation of each bubble and sub-bubble leaves a residue trace; and
activating a residue trace allows backtracking the information search to a higher level.

13. The method of claim 9 wherein:
the search results bubble is displayed on a user display;
the search is modified by formulating a second search request;
a second bubble produced by the search server in response to the second search request is displayed on the user display; and
the two search results are combined by physically combining the bubbles on the user display.

14. The method of claim 8 wherein:
a plurality of search requests are made to the server; and
for each search request, a search results bubble appears on a user display simultaneously with search results bubbles from other search requests.

15. The method of claim 8 wherein:
at least one search dimension is graphically displayed; and
at least one parameter of at least one dimension is adjusted, whereby the displayed search results are visually altered.

16. The method of claim 8 wherein the search request comprises at least one of:
a search string;
a keyword;
a natural language expression;
an entry from within a pre-established menu of entries;
a canonical expression;
an image;
a video;
a fingerprint;
a retinal scan;
a handwritten entry;
a touch on a display.

17. At least one computer-readable medium containing computer program instructions for:
formulating a search request comprising at least two preselected dimensions;
conveying the search request to a server; and
receiving from the server search results organized along the preselected dimensions.

18. Apparatus for initiating and processing computerized data searches, said apparatus comprising:
an input module for establishing a number n of dimensions desired for the search, where n is a positive integer greater than or equal to two;
coupled to the input module, a defining module for defining each dimension;
coupled to the defining module, a search formulation module for accepting and formulating input search queries; and
coupled to the search formulation module, a communications module for sending the search queries to a server and receiving search results from the server.

19. The apparatus of claim 18 further comprising, coupled to the communications module, a modification module adapted to enable a user to modify the search.

20. The apparatus of claim 18 comprising, coupled to the communications module, a display module adapted to display at least one dimension of the search results to the user while preserving non-displayed dimensional search result information.
